(19) United States
(12) Patent Application Publication
(10) Pub. No.: US 2008/0039135 A1
(43) Pub. Date: Feb. 14, 2008

(54) Broadcast communication system for mobile phone

(76) Inventors: Tomoko Nakamura, Tokyo (JP); Hitoshi Hara, Tokyo (JP); Nobutoshi Nakano, Osaka-fu (JP); Yoshiki Nagano, Saitaima-ken (JP); Hidenori Koreishi, Tokyo (JP); Yoshito Hashimoto, Hyogo-ken (JP)

Correspondence Address: BERENATO, WHITE & STAVISH, LLC, 6550 ROCK SPRING DRIVE, SUITE 240, BETHESDA, MD, 20817, US

(21) Appl. No.: 11/822,861

(22) Filed: Jul. 10, 2007

(30) Foreign Application Priority Data
Jul. 11, 2006 (JP) 2006-190150

(51) Int. Cl. H04M 1/00

(52) U.S. Cl. 455/556.1

(57) ABSTRACT

The objective of the present invention is to provide a broadcast communication system for mobile phone, the system capable of switching the broadcast image to the camera image selected from the mobile terminal side for a certain time interval. The system comprises: a broadcast unit 24 capable of broadcasting interactive TV broadcast service to mobile terminals 23 with a TV receiving unit; and a dedicated terminal 27 connected to said mobile terminal 23 over the internet 25 and the public switched telephone network for mobile phone 26; wherein said dedicated terminal 27 includes: a camera selection information sending unit 31 for sending a camera selection information used to select a camera image to said mobile terminal 23; a camera selected information receiving unit 32 for receiving a camera selected information selected from said camera selection information from said mobile terminal 23; and a switching signal output unit 33 for sending a switching signal to said image switching unit 29 of the broadcast unit 24 on the basis of said received camera selected information.

### FIELD OF THE INVENTION

The present invention relates to a broadcast communication system for a mobile phone, the system capable of switching the broadcast image to the camera image selected from the mobile terminal side for a certain time interval and also allowing the download of the camera image, which was switched for the certain time interval, to the mobile terminal as digital content.

### BACKGROUND OF THE INVENTION

Conventionally, as a digital terrestrial broadcast service of this scheme, the following are standardized: a high data rate broadcast service (13 segments per channel) for an installed type of TV receiver set installed in home and the like, and a low data rate broadcast service (1 segment per channel. hereinafter, referred to as “Interactive TV broadcast service”) for a TV receiver set of mainly the mobile terminal type. As a TV receiver set for this Interactive TV broadcast service, for example, the following are known: (1) a TV receiver set of dedicated type designed for easy carrying, (2) a TV receiver generally works as a mobile TV by connecting a module, card, and the like for receiving the digital broadcast service with a mobile terminal, sometimes called a PDA, or a general-purpose information processing apparatus such as personal computer, (3) a mobile phone capable of receiving the digital broadcast service by incorporating a receiver thereto and using the display and the signal processing means thereof.

FIG. 7 is a view schematically illustrating a system of a conventional Interactive TV broadcast service.

Regarding the conventional Interactive TV broadcast service, a mobile terminal 2, which has a function of interactively receiving a TV service, receives a radio channel assigned to an Interactive TV broadcast service broadcasted from a broadcast provider 1, such as a broadcast station, program promoter, and the like, thereby allowing to watch the broadcast image.

This kind of image is a camera image (or preliminary edited video image) selected for ON-AIR (broadcasting) in the broadcast provider 1 by the switching operation of an image selector (AV selector) 3, performed by an operator of the broadcast station, program producer, and the like, and accordingly the viewer views given image.

A broadcast program is originally produced by adequately switching images obtained using a plurality of cameras 4, 4, . . . and/or by editing them thereafter. Therefore a plurality of images actually exist other than the one for ON-AIR, however, a viewer can't watch them.

On the other hand, regarding the Interactive TV broadcast service, text information relating to the program can be displayed on the mobile phone 2; in case of desiring further detailed information, it can be obtained from mobile site 6, namely, a web site for mobile terminal 2, using a communication means of the mobile phone 2 by connecting to the internet 5.

Although this seems like a media obtained by converging the broadcast technology and communication technology, it does not have a direct convergence.

Here, in the figure, 7 denotes a wireless base station, 8 denotes a digital encoder for transforming an analog image to a digital image, and 9 denotes a radio tower for broadcast.

Further, reference is made to, for example, Japanese Patent Application Laid-Open Publication No. 2005-109588 as the one relating to the mobile terminal, which is capable of receiving the digital broadcast service.

### SUMMARY OF THE INVENTION

As described above, there is a problem that a broadcast program is produced by adequately selecting images obtained using a plurality of cameras and/or by editing them thereafter, and therefore a plurality of images actually exist other than the one for ON-AIR. A viewer can't watch them, however.

Considering the state of art, the objective of the present invention is to provide a broadcast communication system for mobile phones, the system capable of switching the broadcast image to the camera image selected from the mobile terminal side for a certain time interval and also allowing the mobile phone to download the camera image switched for the certain time interval as digital content to the mobile terminal.

The aforementioned objective is achieved by the following configurations.

(1) Accordingly, there is provided a broadcast communication system for mobile phone comprising: a broadcast unit capable of broadcasting interactive TV broadcast service to mobile terminals with a TV receiving unit; and a dedicated terminal connected to the mobile terminal over the internet and the public switched telephone network for mobile phone;

The broadcast unit includes: an image switching unit for receiving one or a plurality of camera images and replay images, switching the broadcast image responding to an external operation, and switching the broadcast image for a certain time interval on the basis of a switching signal received from the dedicated terminal; and a broadcast unit for broadcasting the image switched by the image switching unit to the mobile terminals.

The dedicated terminal includes: a camera selection information sending unit for sending a camera selection information used to select a camera image to the mobile terminal; a camera selected information receiving unit for receiving a camera selected information selected from the camera selection information from the mobile terminal; and a switching signal output unit for sending a switching signal to the image switching unit on the basis of the received camera selected information.

According to the present invention, it is possible to provide a broadcast communication system for a mobile phone capable of switching the broadcast image to the camera image selected from the mobile terminal side for a certain time interval.

(2) Accordingly, there is provided a broadcast communication system for mobile phone according to claim 1, wherein the dedicated terminal includes: an editing unit for editing the broadcast image, which is switched for the certain time interval on the basis of the camera selected information, as a digital content; a storage unit for storing the digital content; a content selection information sending unit for sending the content selection information used to select a digital content to be downloaded, to the mobile terminal; a content selected information receiving unit for receiving the content selected information selected from the content selection information from the mobile terminal; an extraction unit for extracting the digital content from the storage unit on the basis of the received content selected information; and a content sending unit for sending the extracted digital content to the mobile terminal.

According to the present invention, it is possible to download the camera image, which was switched for the certain time interval and is the broadcasted image selected from the mobile terminal side, to the mobile terminal as a digital content.

According to the present invention, a method of broadcasting image content associated with a plurality of cameras to at least one mobile terminal is provided. The method includes receiving a first broadcast image associated with a first camera at the at least one mobile terminal, the first broadcast image being received from a broadcast unit, enabling an input camera selection at the at least one mobile terminal, the input camera selection requesting a second broadcast image associated with a second camera, transmitting the input camera selection to the broadcast unit for controlling the broadcast unit to switch from broadcasting the first broadcast image to broadcasting the second broadcast image, when the input camera selection is received, and receiving the second broadcast image at the at least one mobile terminal in response to the transmission of the input camera selection, the second broadcast image being received from the broadcast unit.

According to the present invention, a method of broadcasting image content associated with a plurality of cameras to at least one mobile terminal is provided. The method includes broadcasting a first camera image signal associated with a first camera to at least one mobile terminal via radio waves, receiving a request for a second camera image signal associated with a second camera from the at least one mobile terminal via a digital communications network, and broadcasting the second camera image signal to the at least one mobile terminal via the radio waves, in response to the received request.

### BRIEF DESCRIPTION OF THE DRAWING

FIG. 1 is a view for explaining the function of a broadcast communication system for mobile phone according to the present invention;

FIG. 2 is a schematic view illustrating an exemplary broadcast communication system for mobile phones according to the present invention;

FIG. 3 is a view illustrating changes of the display image according to the VOD broadcast service broadcasted by a broadcast communication system for a mobile phone in accordance with the present invention;

FIG. 4 is a flow chart of the process sequence according to the VOD broadcast service broadcasted by a broadcast communication system for a mobile phone in accordance with the present invention;

FIG. 5 is a view for explaining the VOD transmission service offered by a broadcast communication system for mobile phones in accordance with the present invention, over the internet;

FIG. 6 is a flow chart of the process sequence according to the VOD transmission service offered by a broadcast communication system for mobile phones in accordance with the present invention over the internet; and

FIG. 7 is a view for explaining an exemplary, conventional interactive TV service.

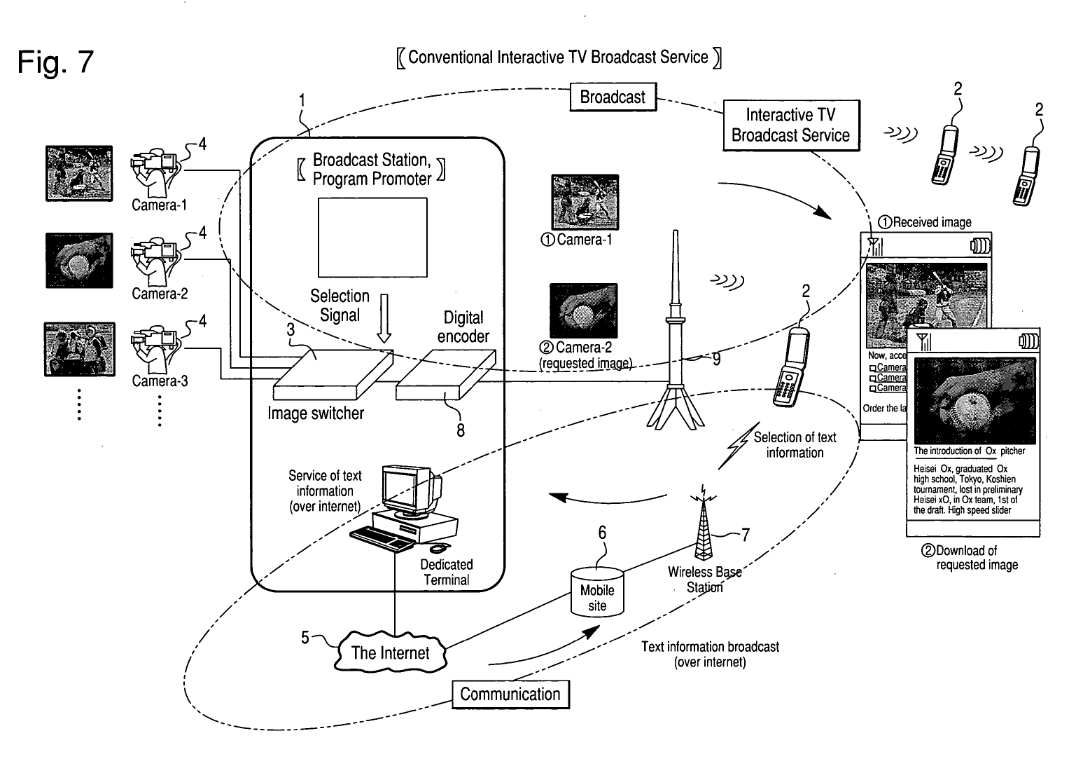

### DETAILED DESCRIPTION OF THE PREFERRED EMBODIMENTS

Hereinafter, described are embodiments according to the present invention, with reference to the drawings which shows illustrative examples.

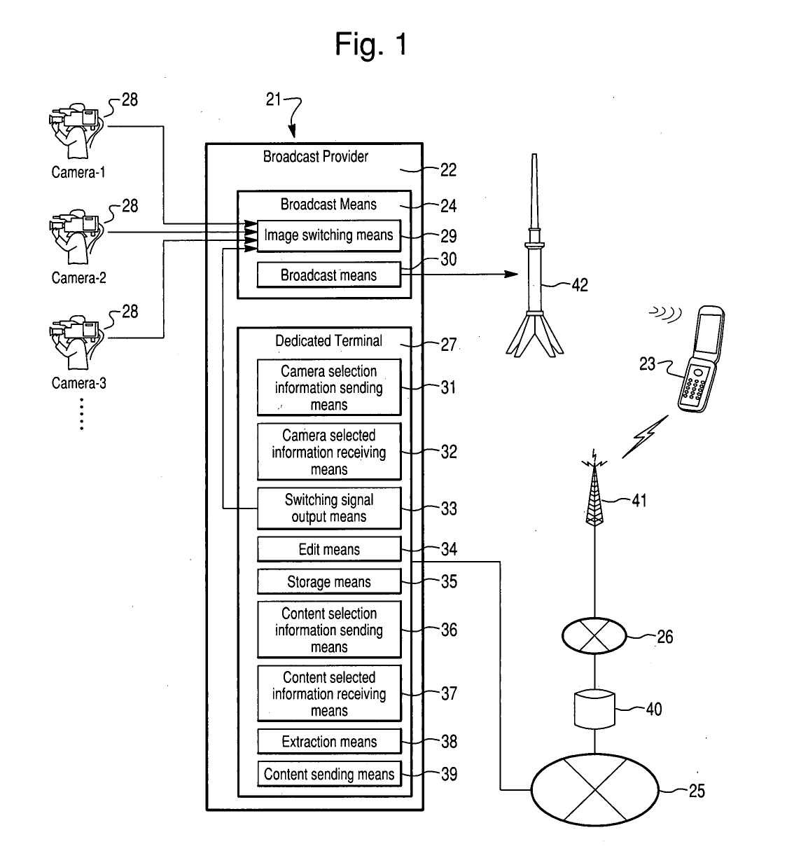

In FIG. 1, 21 denotes a broadcast communication system for mobile phones according to the present invention. The broadcast communication system 21 for mobile phones comprises a broadcast unit 24 formed inside the room of a broadcast provider 22, such as a broadcast station, program promoter, etc.; and capable of broadcasting Interactive TV broadcast services to a mobile terminal 23 having a TV receiver unit, and a dedicated terminal 27 capable of communication with the mobile terminal 23 over the internet 25 and the public switched telephone network for mobile phone 26. Here, one or plurality of mobile terminal(s) 23 can communicate with the system, however, descriptions are performed by assuming one mobile terminal.

The broadcast unit 24 includes an image switching unit 29 for receiving one or a plurality of camera image(s) obtained by one or a plurality of camera(s) 28, 28, . . . switching the broadcast image depending on the external operation by a stuff and the like, and switching the broadcast image for a certain time interval on the basis of a switching signal received from the dedicated terminal 27; and a broadcast unit 30 for broadcasting the broadcast image switched by the image switching unit 29 to the mobile terminal 23.

The dedicated terminal 27 includes a camera selection information sending unit 31 for sending selection information used to select camera image, to the mobile terminal 23; a camera selected information receiving unit 32 for receiving camera selected information, which is selected from the selection information from the mobile terminal 23; and a switching signal output unit 33 for outputting a switching signal to the image switching unit 29 on the basis of the received camera selected information.

Further, the dedicated terminal 27 includes an edit unit 34 for editing the broadcast image switched for the certain time interval on the basis of the selected information as digital content; a storage unit 35 for storing digital content; a content selection information sending unit 36 for sending content selection information used to allow the selection of the digital content to be downloaded to the mobile terminal 23; a content selected information receiving unit 37 for receiving content selected information selected from the content selection information from the mobile terminal 23; an extraction unit 38 for extracting digital content from the storage unit 35; and a content sending unit 39 for sending the extracted digital content to the mobile terminal 23.

Here, in the Figures, 40 denotes a mobile site or a web site for the mobile terminal 23, 41 denotes a wireless base station, and 42 denotes a radio tower for broadcasting.

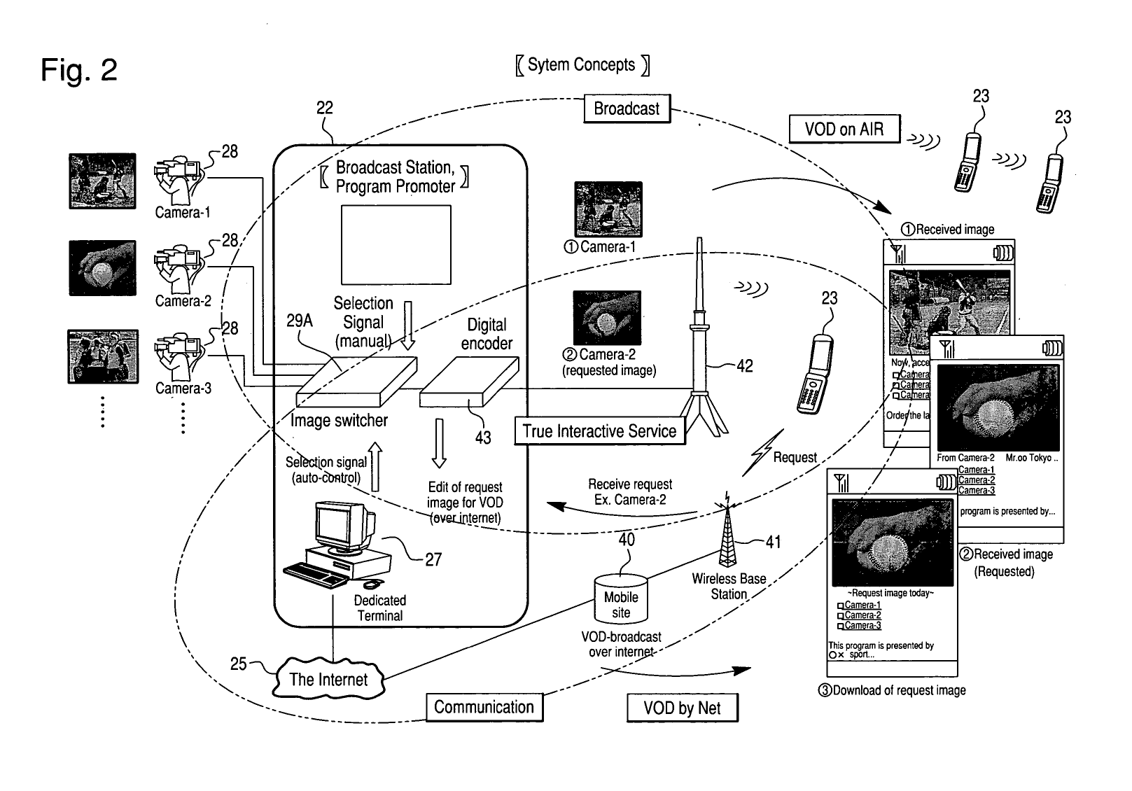

Referring to FIG. 2, the broadcast communication system 21 for mobile phone according to the present invention is further described in detail.

Radio waves broadcasted from the broadcast provider 22, such as a broadcast station or program promoter, are received by a mobile terminal 23 as an interactive TV receiving terminal, and thereby the broadcasted image is viewed by a viewer via the mobile terminal 23.

In this case, the broadcasted image is a camera image (hereinafter, referred to as “main selected image”) selected for ON-AIR by means that the stuff of the broadcast provider 22 such as broadcast station, program promoter etc., carried out switching operation of an image switcher 29A, namely, the image switching means 29.

Besides, the received broadcast image, that is the main selected image, and text information linked to the broadcast image are simultaneously displayed on the mobile terminal 23. However, some broadcast programs can be configured as an audience participation program by means of a broadcasting text information, namely, camera selection information, used to select a “request image”, which is used to selectively request a broadcast image from a plurality of camera images.

For example, by way of broadcasting the camera selection information used to select camera image from those obtained by a plurality of cameras (camera-1, camera-2, camera-3, . . . ) 28, 28 . . . , to the mobile terminal 23, in the event that a viewer selected, for example, “camera-2” from the camera selection information, the camera selected information showing the selection of “camera-2” is sent to the dedicated terminal 27 by the communication function of the mobile terminal 23 over the internet 25.

The dedicated terminal 27 receives the camera selected information, namely, received request signal showing the selection of “camera-2”, controls the image switcher 29A, namely, the image switching means 29, connected via an external interface (serial interface, LAN interface, and the like), thereby switches to the camera image corresponding to “camera-2” as the selected image for ON-AIR, and sends it.

Thereby, it is possible to broadcast a camera image requested by a viewer. That is, one may offer a VOD broadcast service (VOD ON-AIR), and accordingly, realize the so-called interactive world combining communication with broadcast.

Here, owing to the use of the public radio channel, the maximum broadcast time of the request image (camera image) is set to approximately 5 minutes. After the elapse of the set time, the broadcast image (ON AIR) is switched back to the original one, that is, the main selected image.

Beside, the social order should be kept by such as previously setting, in the program slot, the so-called “request corner” (a time slot) for allowing the request, which is realized by using the function according to the present invention.

It is possible to broadcast the introduction of the viewer whose request is adopted, commercial message, and the like by associating with the aforementioned information, as the text information.

Further, on the other hand, by way of storing the requested broadcast image as edited digital content, it is possible to offer the VOD transmission service over the internet (VOD by-Net) to the mobile terminal 23 from the dedicated terminal 27.

Here, in FIG. 2, 43 denotes a digital encoder for transforming an analog signal to a digital signal.

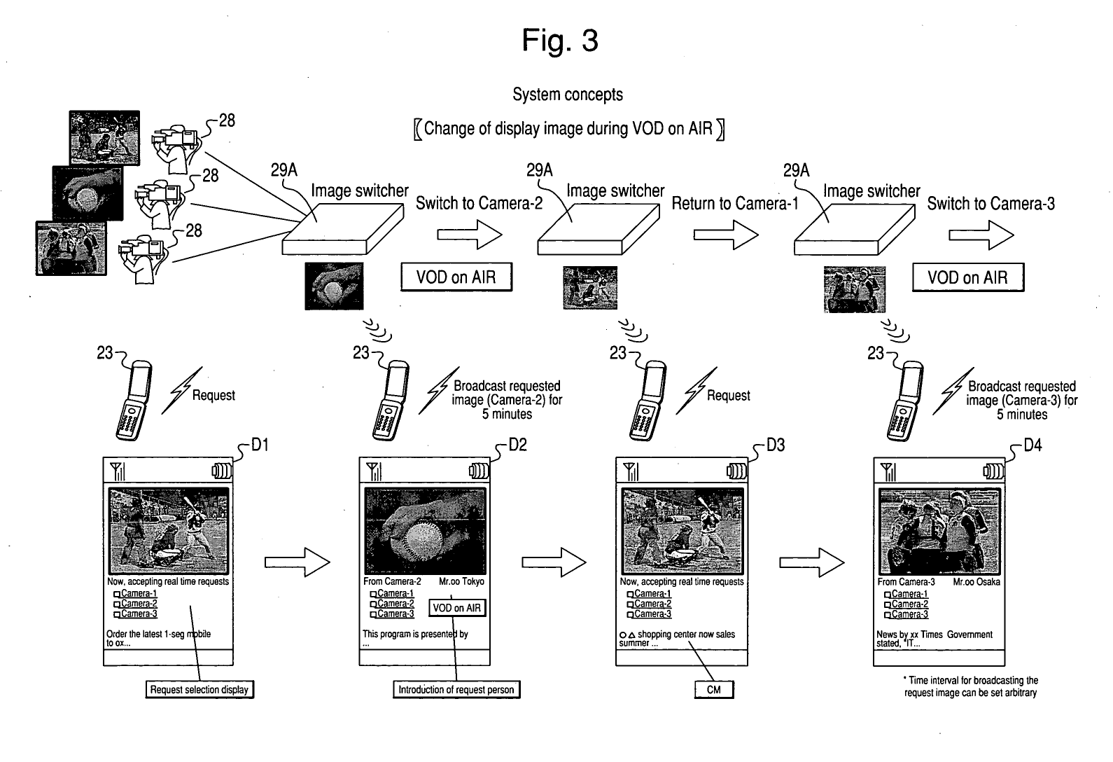

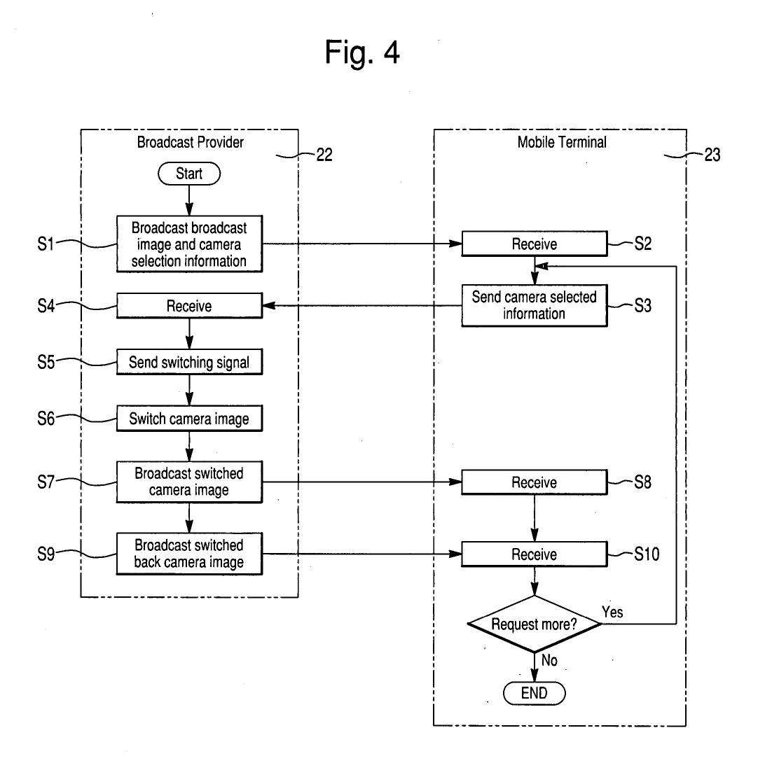

FIG. 3 is a view illustrating the switching of the camera image according to the so-called VOD broadcast service, by which the camera image requested by a viewer is broadcasted as a broadcast image, in the broadcast communication system 21 for mobile phone in accordance with the present invention. FIG. 4 is a flow chart of the process sequence according to the VOD broadcast service, in the broadcast communication system 21 for mobile phone in accordance with the present invention. Referring to the FIG. 1, description is performed by accompanying with FIGS. 3 and 4.

Usually, the broadcast station, program promoter, and the like carries out the switching operation of the image switcher (AV selector) 29A in the broadcast provider 1. A selected camera image (or, pre-edited image) for ON-AIR, namely, the main selected image, is broadcasted as broadcast image (step S1), and a viewer watches the given image (step S2), as best shown in FIG. 4.

At the moment, in the broadcast communication system 21 for mobile phone according to the present invention, a broadcast image window 51 and a text information window 52 for displaying the text information adaptively sent from a sending unit (not shown) of the dedicated terminal 27 are displayed on the display. D1 of the mobile terminal 23. The camera selection information is displayed in the text information window 52 (shown in the figure as “now, accepting real time requests”) (step S2), where the camera selection information is used to allow the selection of the camera image and sent (in the step S1) from the camera selection information sending unit 31 of the dedicated terminal 27 to the mobile terminal 23. The camera selection information is information used to request switching of the broadcast image to the selected camera image.

When the user of the mobile terminal 23 has selected, for example, “camera-2” on the window, the camera selected information is sent to the camera selected information receiving means 32 of the dedicated terminal 27 from the mobile terminal 23 over the internet 25 (step S3). When the camera selected information receiving means 32 has received the camera selected information (step S4), a switching signal is sent by the switching signal output means 33 to the image switcher 29A, namely, the image switch means 29 (step S5). The image switcher 29A switches the broadcast image to the camera image of the “camera-2” (step S6), and the camera image of “camera-2” is broadcasted from the broadcast means 30 (step S7).

The mobile terminal 23 receives the camera image of the “camera-2” (step S8), and the camera image of the “camera-2” is displayed in the broadcast image window 51 of the mobile terminal 23 like a display D2 (FIG. 3).

In the meanwhile, the information indicating the requested image of the “camera 2” and introducing the person making the request is displayed as a running telop in the text information window 52 of the mobile terminal 23 as a text information sent from the mobile terminal 27.

Here, it is also possible to display characters and image for CM and the like or display as a running telop, in the text information window 52.

Owing to the restriction on broadcasting, the requested image of “camera-2” is switched back, for example, after 5 minutes, to the camera image selected by the switching operation of the image switcher 29A, performed by the stuff of the broadcast station, program promoter, and the like, that is, the main selected image; and then the switched back main selected image is broadcasted (step S9). At the moment, it is displayed on the mobile terminal 23 like a display D3. The time slot for broadcasting the request image can be arbitrarily determined.

Next, when the user of the mobile terminal 23 has selected “camera-3” (step S3), the image switcher 29A switches the camera image to that of the “camera-3” on the basis of the switching signal (step S6). The camera image of the “camera-3” is broadcasted from the broadcast means 30 (step S7). The mobile terminal 23 receives the camera image of the “camera-3” in a manner similar to the aforementioned one (step S8), and thereby the camera image of the “camera-3” is displayed on the broadcast image window 51 of the mobile terminal 23 like a display D4.

Here, in case that there are a large number of requests from the mobile terminal, requests are adequately selected and adopted in the dedicated terminal 27 and the main program is not occupied by requests.

Beside, the social order should be kept as previously set, in the program slot, the so-called “request corner” (a time slot), where the function according to the present invention is utilized. Further, in case that a request is taken, it is also possible to charge on it.

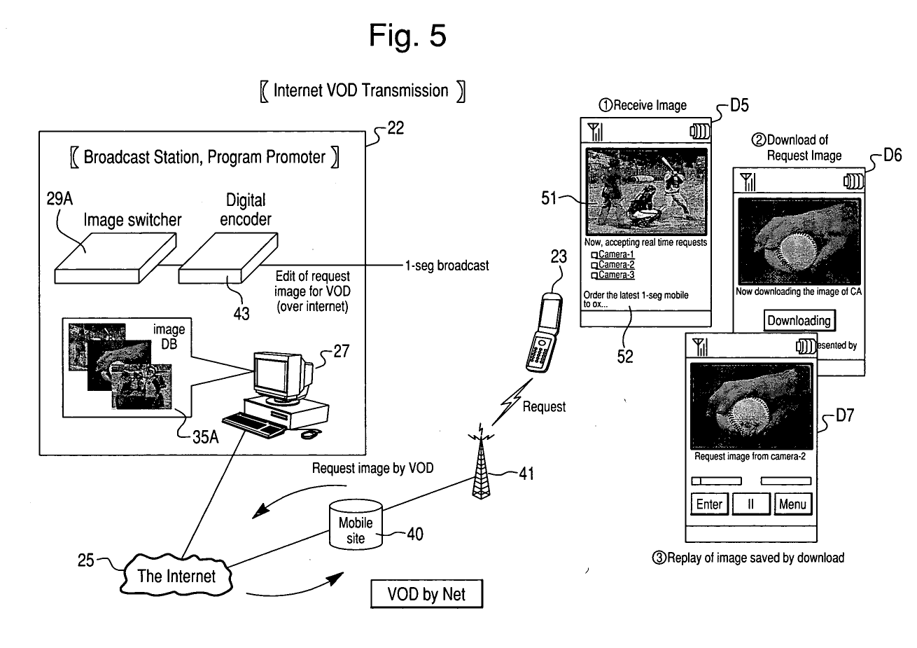

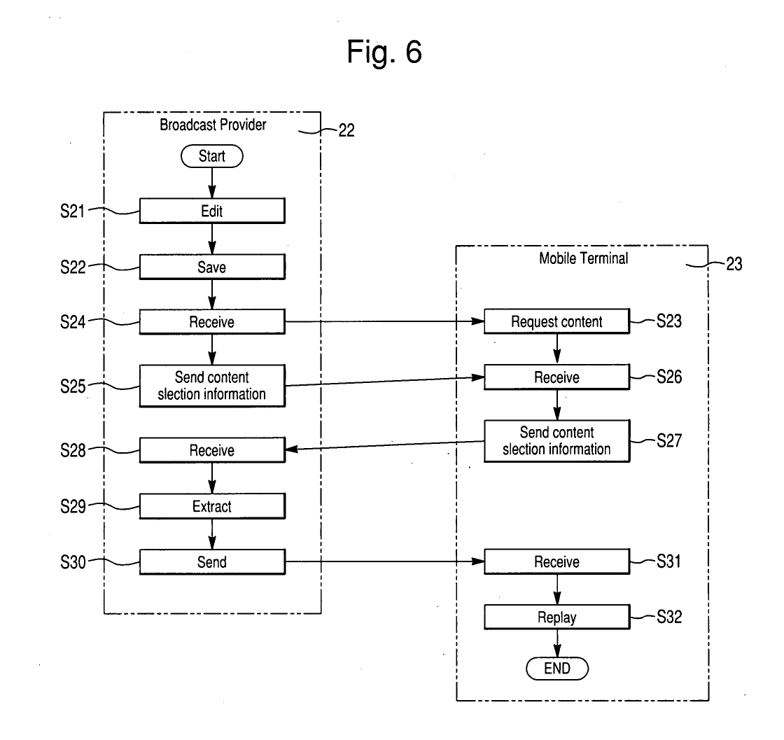

FIG. 5 is a schematic view illustrating a service for transmitting the camera image requested by a viewer from the dedicated terminal 27 over the internet. That is, the VOD transmission service is offered over the internet. FIG. 6 is a flow chart on the VOD transmission service offered over the internet. Referring to the FIG. 1, description is performed by accompanying with FIGS. 5 and 6.

When the camera image requested by the aforementioned viewer is broadcast, that is, during the VOD broadcast service, the requested image is edited by the edit unit 34 of the dedicated terminal 27 (step S21). Then it is stored as content in the storage unit 35, such as video image database (DB) 35A (step S22).

When, at the request of the mobile terminal 23 (steps S23, S24), content selection information has been sent from the content selection information sending unit 36 of the dedicated terminal 27 to the mobile terminal 23 (steps S25, S26), the content selection information (shown in the figure as “˜Request image today˜”) is displayed in the text information window 52 of display D5 of the mobile terminal 23. Thereby desired content from the content selection information can be selected by means of the mobile terminal 23. Then the content selected information sent from the mobile terminal 23 is received by the content selected information receiving unit 37 of the dedicated terminal 27 over the internet 25 (steps S27, S28).

When the content selected information is received by the content selected information receiving unit 37, the content is extracted, on the basis of the content selected information, by the extraction unit 38 from the storage unit 34 (step S29). Then the extracted content is sent by the content sending unit 39 to the mobile terminal 23 over the internet 25 (step S30).

The mobile terminal 23 can download the content (refer to the display D6) (step S31) and replay it (refer to the display D7) (step S32).

Here, it is possible to charge for the download of the content.

Further, the saved image from the download can have a set term of validity and no allowance for copying, forwarding and the like.

Here, it should not be construed that the content selection information is not limited to the one illustrated in the figure as “˜Request image today˜”, but it is also possible to allow the selection of the past request image.

Still further, the available content is not limited to the content stored in the storage unit 35 during the VOD broadcast service, but may be content stored in the storage unit 35 by the other method.

Yet further, the mobile terminal 23 may also be a mobile terminal with a variety of functions, for example, one with an IC tag reader based on the international standard.

What is claimed is:

1. A broadcast communication system for a mobile phone, comprising:
a broadcast unit capable of broadcasting interactive TV broadcast service to mobile terminals with a TV receiving unit; and
a dedicated terminal connected to the mobile terminals over the internet and a public switched telephone network for mobile phones;
wherein said broadcast unit includes:
an image switching unit for receiving one or more of a camera image and a replay image, switching the broadcast image responding to external operation, and switching the broadcast image for a certain time interval based on a switching signal received from said dedicated terminal; and
a broadcast unit for broadcasting the image switched by said image switching unit to the mobile terminal;
wherein said dedicated terminal includes:
a camera selection information sending unit for sending camera selection information used to select a camera image to the mobile terminal;
a camera selected information receiving unit for receiving a camera selected information selected from said camera selection information from the mobile terminal; and
a switching signal output unit for sending a switching signal to said image switching unit on the basis of said received camera selected information.

2. A broadcast communication system for a mobile phone according to claim 1, wherein said dedicated terminal further includes:
an editing unit for editing the broadcast image, which is switched for the certain time interval on the basis of said camera selected information, as digital content;
a storage unit for storing the digital content;
a content selection information sending unit for sending content selection information used to select digital content to be downloaded, to the mobile terminal;
a content selected information receiving unit for receiving the content selected information selected from said content selection information of the mobile terminal;
an extraction unit for extracting the digital content from said storage unit on the basis of the received content selected information; and
a content sending unit for sending the extracted digital content to said mobile terminal.

3. A broadcast communication system for a mobile phone according to claim 1, wherein the broadcast unit further comprises:
a digital encoder for transforming the broadcast image from analog signal format to digital signal format and for providing the digital image signal to the dedicated terminal.

4. A broadcast communication system for a mobile phone according to claim 1, wherein the broadcast unit is associated with a broadcast tower that broadcasts the broadcast image to a plurality of mobile terminals via radio waves.

5. A method of broadcasting image content associated with a plurality of cameras to at least one mobile terminal, the method comprising:
receiving a first broadcast image associated with a first camera at the at least one mobile terminal, the first broadcast image being received from a broadcast unit;
enabling an input camera selection at the at least one mobile terminal, the input camera selection requesting a second broadcast image associated with a second camera;
transmitting the input camera selection to the broadcast unit for controlling the broadcast unit to switch from broadcasting the first broadcast image to broadcasting the second broadcast image, when the input camera selection is received; and
receiving the second broadcast image at the at least one mobile terminal in response to the transmission of the input camera selection, the second broadcast image being received from the broadcast unit.

6. The method of claim 5, including the step of providing as the first and second broadcast images different viewpoints of the same event.

7. The method of claim 5, including the step of transmitting the input camera selection from the at least one mobile terminal to a dedicated terminal associated with the broadcast unit via a digital communication network.

8. The method of claim 5, including the step of transmitting the input camera selection from the at least one mobile terminal to a dedicated terminal associated with the broadcast unit via a digital communication network via at least one of the Internet and a public switched telephone network.

9. The method of claim 5, further comprising:
restoring the first broadcast image automatically after a predetermined time period of receiving the second broadcast image has elapsed.

10. The method of claim 5, further comprising:
receiving camera selection information from the dedicated terminal associated with the broadcast unit via a digital communications network and displaying the camera selection information on the at least one mobile terminal, the camera selection information indicative of various camera viewing options.

11. The method of claim 5, further comprising:
enabling a content download selection at the at least one mobile terminal, the content download selection requesting a download of a stored camera image associated with the broadcast unit;
transmitting the content download selection to a dedicated terminal associated with the broadcast unit, when the content download selection is received by the at least one mobile terminal; and
receiving the stored camera image from the dedicated terminal in response to the transmission of the content download selection.

12. The method of claim 11, wherein the step of transmitting the content download selection comprises transmitting the content download selection by the at least one mobile terminal via a digital communications network, and the stored camera image is received via the digital communications network.

13. The method of claim 5, wherein the enabling of the input camera selection at the at least one mobile terminal comprises providing a user interface on the at least one mobile terminal, the user interface including image information and text information indicative of various camera viewing options, and the image information is received via an analog broadcast and the text information is received via a digital communication.

14. A method of broadcasting image content associated with a plurality of cameras to at least one mobile terminal, the method comprising:
broadcasting a first camera image signal associated with a first camera to at least one mobile terminal via radio waves;
receiving a request for a second camera image signal associated with a second camera from the at least one mobile terminal via a digital communications network; and
broadcasting the second camera image signal to the at least one mobile terminal via the radio waves, in response to the received request.

15. The method of claim 14, further comprising:
transmitting input camera selection information to display on the at least one mobile terminal, the input camera selection indicative of various camera viewing options.

16. The method of claim 14, further comprising:
storing at least one camera image signal;
receiving a content download request from the at least one mobile terminal, the content download request associated with the at least one stored camera image signal; and
in response to the content download request, transmitting the at least one stored camera image signal to the at least one mobile terminal.

17. The method of claim 14, wherein the broadcasting of the second camera image signal to the at least one mobile terminal comprises switching footage of an event being broadcasted over the radio waves from the first camera to the second camera.

18. The method of claim 14, wherein:
broadcasting the first and second camera image signals comprises controlling a radio tower to broadcast a television image signal over the radio waves; and
receiving the request comprises receiving an instruction via the digital communications network and controlling the radio tower, in response to the received instruction.

19. The method of claim 14, further comprising:
simultaneously receiving a plurality of camera image signals from the plurality of cameras, each camera image signal associated with a different viewpoint of an event; and
switching among the plurality of camera image signals being broadcast based on selection commands received from the at least one mobile terminal.

20. The method of claim 14, wherein the first and second camera image signals are broadcast to a plurality of mobile phones.
